(19) United States
(12) Patent Application Publication
(10) Pub. No.: US 2009/0226256 A1
(43) Pub. Date: Sep. 10, 2009

(54) Asphalt melting device and system

(76) Inventor: Roger Alain, Port Moody (CA)

Correspondence Address: FLYNN THIEL BOUTELL & TANIS, P.C., 2026 RAMBLING ROAD, KALAMAZOO, MI, 49008-1631, US

(21) Appl. No.: 12/378,815

(22) Filed: Feb. 19, 2009

(30) Foreign Application Priority Data
Feb. 20, 2008 (CA) 2 621 889

(51) Int. Cl. E01C 23/14; G05D 23/00; G06F 17/00; G06F 1/26

(52) U.S. Cl. 404/95; 700/300; 700/265; 700/295

(57) ABSTRACT

An electrically powered mobile asphalt melting unit and system. The device comprises a housing to receive and retain solid asphalt, liquid asphalt and solid and liquid asphalt mixtures. The housing comprises a base, side walls, an upper cover, an asphalt input aperture, an asphalt outlet and venting means. An electric power means is secured to the housing and operatively connected to an electric power source; electric heating means secured within the housing are operatively connected to the electric power means; and heating control means operatively connected to the electric heating means selectively regulate the temperature of asphalt contained within the housing. The system comprises asphalt loading means, an electric heating means, computer control means for controlling the temperature of the electric heating means, and electric power means to supply power selectively to the electric heating means.

### PRIORITY CLAIM

Applicant claims priority to Application CA 2,621,889, filed Feb. 20, 2008, the entire contents of which are incorporated herein by reference.

### FIELD OF THE INVENTION

The invention relates to the melting of asphalt products, more particularly to electrically powered heating devices for on-site melting of asphalt products, including rubberized asphalt, for application to building roofs and similar surfaces.

### BACKGROUND OF THE INVENTION

For sealing and protecting roofs of buildings, it is known to apply molten products, typically asphalt or rubberized asphalt. These are conventionally melted in close proximity to the work site, either on a roof adjacent to the location to which the molten product is to be applied, or adjacent to a building under construction. The melting units, generally known as kettles, typically comprise a container into which solid pieces of asphalt are placed, and a fuel burner, now typically propane, is operated to provide heat, by an open flame, to the kettle. After the asphalt is in a molten condition at the required temperature, the flame can be adjusted to maintain the product at that temperature, while the molten product is removed from the kettle and applied as required to the site surface.

Although the known kettles are simple and effective, they also suffer from several disadvantages, particularly resulting from the use of open flame as the heat source. Firstly, having regard to the numerous readily flammable materials on work sites, particularly new building construction sites, there is the inherent fire hazard. Although the burners can be provided with shielding or other protection to reduce the risk of causing fires to materials on site, some residual risk nevertheless remains. Secondly, as the result of this risk, governmental authorities in several jurisdictions have recently introduced legislative provisions to regulate or prohibit the use of open flame heat sources in many situations, in particular on roofs of new buildings, and more particularly on new high-rise buildings. Thirdly, precise control of the temperature of the molten product within the kettle is difficult where the heat source is an open flame, particularly as the removal of the contents during application to a roof or similar surface, and conversely the addition of further solid product to replenish the asphalt within the kettle, alters the volume of product within the kettle, and consequently the heat supply required from time to time to maintain this varying volume of molten product at the desired temperature.

It is also known to conduct the melting operation, in a conventional kettle, at ground level adjacent a building to which the molten product is to be applied, and to deliver the molten product as required through a delivery pipe, by suitable pumping means. However, except for very short lengths of pipe, it is necessary to provide heating means, typically an electric coil or similar, to the pipe to maintain the molten product within the appropriate temperature range so that it will flow as required and be at the proper temperature for effective application when delivered by the pipe to the application site surface. Clearly, the greater the distance between the kettle and the application site surface, the more difficulty there will be in ensuring that the molten product is in the appropriate condition, and the more expense incurred in order to provide sufficient heating means to the delivery pipe.

It is known to provide various heating sources for asphalt for other construction applications, for example road paving operations. In particular it is known to use electric heating means for such operations, where this can readily be provided by means of a power connection to a vehicle. However, such methods of providing heat to melt an asphalt product and maintain it in a molten condition within a required temperature range cannot feasibly be adapted for use in many building construction sites, in particular on roofs or any other significantly elevated surface.

As a further problem in seeking to provide an effective method for such elevated surfaces, many existing buildings, and most new construction sites at the time at which roofing asphalt will be applied, are supplied only by single-phase electric power, rather than three-phase power, which can result in further problems in situations where three-phase power is preferred or required.

### SUMMARY OF THE INVENTION

It has now been found that an asphalt melting device and system can be provided, in which all the advantages of the conventional flame-heated devices are retained, including simplicity, portability, and economy, but wherein the heat is provided by electrical means, resulting in a device which complies with safety standards currently imposed or projected for a foreseeable future date. In the following discussion, the term “asphalt” should be read as including related asphalt products, including but not restricted to rubberized asphalt.

The invention therefore seeks to provide a device for melting asphalt comprising
(i) a housing constructed and arranged to receive and retain solid asphalt, liquid asphalt and mixtures thereof, the housing comprising a base, side walls, an upper cover, an asphalt input aperture, an asphalt outlet and venting means;
(ii) an electric power means constructed and arranged to be secured to the housing and to be operatively connected to an electric power source;
(iii) electric heating means secured within the housing and constructed and arranged to be operatively connected to the electric power means; and
(iv) heating control means operatively connected to the electric heating means to selectively regulate the temperature of asphalt contained within the housing.

The invention further seeks to provide a system for an electrically powered mobile asphalt melting unit comprising:
(a) an asphalt loading means;
(b) an electric heating means;
(c) computer control means for controlling the temperature of the electric heating means; and
(d) electric power means to supply power selectively to the electric heating means.

The device and system can be provided with asphalt agitation means constructed and arranged to be releasably secured within the housing, and comprising agitation control means. Preferably, if provided, the asphalt agitation means is constructed and arranged to be operatively connected to the electric power means and comprises an agitation rack.

Preferably, the electric power means comprises a motor constructed and arranged to be connected to either a single-phase or a three-phase power supply. Preferably the heating means is provided with three-phase power. For use in locations in which three-phase power supply is not readily available, the device can be provided with a converter constructed and arranged to be operatively connected to single-phase power supply and to convert the single-phase power to three-phase power for the heating means.

Preferably, the electric heating means comprises a plurality of heating rods, and more preferably the heating rods comprise flange immersion tubular elements. Heat can be supplied to the rods through a fluid medium such as a reservoir of air or oil.

Preferably, the asphalt outlet is operatively connected to an output delivery means, more preferably a delivery pipe provided with temperature regulation means, which most preferably is electrically powered.

### BRIEF DESCRIPTION OF THE DRAWINGS

The invention will now be described with reference to the drawings, in which

FIG. 1 is a schematic representation of an embodiment of the invention; and

FIG. 2 is an electrical diagram of an embodiment of the invention.

### DETAILED DESCRIPTION OF THE DRAWINGS

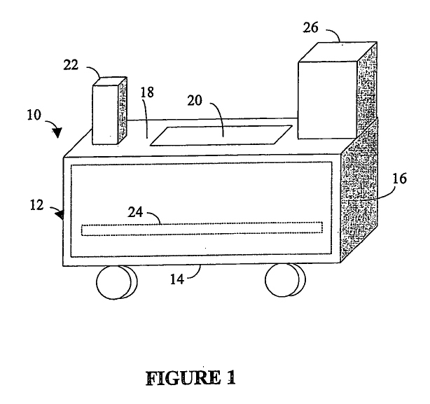

Referring to FIG. 1, a kettle 10 comprises a housing 12, having a base 14, side walls 16, and an upper cover 18. An inlet aperture 20, which is provided with a suitable cover (not shown), allows for solid asphalt (not shown) to be added into the kettle 10. At a suitable location, the kettle 10 is provided with a conventional vent 22, and an outlet (not shown) for delivery of the molten product through conventional means. In the interior of the kettle 10, heating means such as rods, preferably flange immersion tubular rods, identified generally as 24, are secured appropriately, longitudinally to extend substantially between two opposing side walls 16. Within the kettle, agitator means, such as a conventional agitation rack (not shown) can optionally be releasably secured, particularly for applications where the asphalt product is a rubberized asphalt; and the agitator means is operated selectively according to the condition of the asphalt product within the kettle 10.

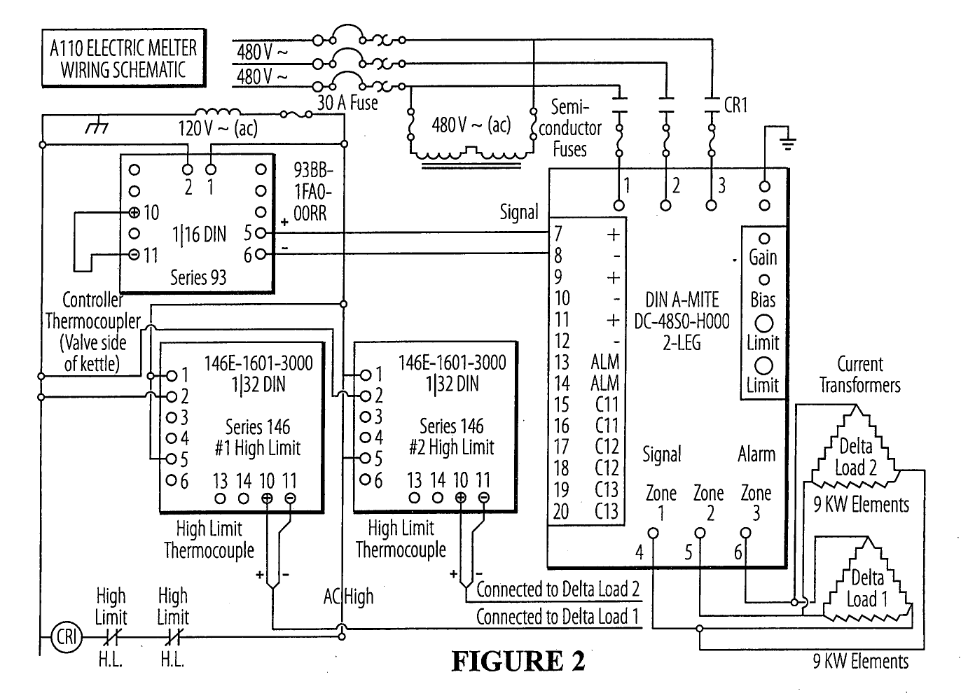

Outside the housing 12 of the kettle 10, a control region 26 comprises the components required to deliver electric power to the kettle 10, for its operation. An electrical diagram for the operation of the kettle is shown in FIG. 2.

The electrical components at control region 26, which are not specifically shown individually in FIG. 1, include electric power means; power connections from the motor to each of the agitator means and each of the heating rods 24; and computer controls for selectively regulating the operation of each of the electrical components. In addition, a converter (not shown) can be provided to the control region 26, to convert single-phase power to provide three-phase power to the heating means, such as the heating rods 24.

The kettle 10 can be provided with suitable delivery means (not shown) for the molten product, such means including conventional pipes, which can optionally be provided with heating means, to maintain the required temperature of the molten asphalt until application on the site surface. However, for situations where the kettle 10 can be placed close to the point of application, supplementary heating means for the delivery pipe may be unnecessary.

In operation, the kettle 10 is first brought to the selected site location. Asphalt is loaded into the kettle 10 through inlet aperture 20. Electrical connection is made between the motor and the power supply source and, using the converter if required, power is supplied to the heating rods 24, to commence the melting process. When there is a sufficient volume of molten asphalt, the agitation means are activated to stir the molten asphalt, and accelerate the creation of the required volume of available molten product. Thereafter, the product can be delivered out of the kettle and applied in the conventional manner to the surfaces to be treated.

Preferably, the various components of the kettle can be readily removed, to facilitate cleaning and removal to and from application sites.

1. A device for melting asphalt comprising
(i) a housing constructed and arranged to receive and retain solid asphalt, liquid asphalt and mixtures thereof, the housing comprising a base, side walls, an upper cover, an asphalt input aperture, an asphalt outlet and venting means;
(ii) an electric power means constructed and arranged to be secured to the housing and to be operatively connected to an electric power source;
(iii) electric heating means secured within the housing and constructed and arranged to be operatively connected to the electric power means; and
(iv) heating control means operatively connected to the electric heating means to selectively regulate the temperature of asphalt contained within the housing.

2. A device according to claim 1, further comprising asphalt agitation means constructed and arranged to be releasably secured within the housing, and comprising agitation control means.

3. A device according to claim 1, wherein the electric power means comprises a motor constructed and arranged to be connected to a power supply selected from a single-phase power supply and a three-phase power supply.

4. A device according to claim 1, further comprising a converter constructed and arranged to selectively convert single-phase power from the electric power means to three-phase power for delivery to the electric heating means.

5. A device according to claim 1, wherein the electric heating means comprises a plurality of heating rods.

6. A device according to claim 5, wherein the heating rods comprise flange immersion tubular elements.

7. A device according to claim 5, wherein the electric heating means further comprises a reservoir of a heating medium selected from air and oil.

8. A device according to claim 2, wherein the asphalt agitation means is constructed and arranged to be operatively connected to the electric power means and comprises an agitation rack.

9. A device according to claim 1, wherein the asphalt outlet is operatively connected to an output delivery means.

10. A device according to claim 9, wherein the output delivery means comprises a pipe provided with temperature regulation means.

11. A device according to claim 10, wherein the temperature regulation means is electrically powered.

12. A system for an electrically powered mobile asphalt melting unit comprising:
(a) an asphalt loading means;
(b) an electric heating means;
(c) computer control means for controlling the temperature of the electric heating means; and
(d) electric power means to supply power selectively to the electric heating means.

13. A system according to claim 12, further comprising an asphalt agitation means constructed and arranged to be operatively connected to the electric power means.

14. A system according to claim 12, wherein the electric power means comprises a motor constructed and arranged to be connected to a power supply selected from a single-phase power supply and a three-phase power supply.

15. A system according to claim 12, further comprising a converter constructed and arranged to selectively convert single-phase power from the electric power means to three-phase power for delivery to the electric heating means.

16. A system according to claim 12, wherein the electric heating means comprises a plurality of heating rods.

17. A system according to claim 16, wherein the heating rods comprise flange immersion tubular elements.

18. A system according to claim 16, wherein the electric heating means further comprises a reservoir of a heating medium selected from air and oil.

19. A system according to claim 13, wherein the asphalt agitation means is constructed and arranged to be operatively connected to the electric power means and comprises an agitation rack.

20. A device according to claim 12, wherein the asphalt outlet is operatively connected to an output delivery means.

21. A device according to claim 20 wherein the output delivery means comprises a pipe provided with temperature regulation means.

22. A device according to claim 21, wherein the temperature regulation means is electrically powered.
